(19) United States
(12) Patent Application Publication
(10) Pub. No.: US 2026/0196685 A1
(43) Pub. Date: Jul. 9, 2026

(54) SECONDARY BATTERY

(71) Applicant: SAMSUNG SDI CO., LTD., Yongin-si (KR)

(72) Inventor: Suk Jun KANG, Yongin-si, Gyeonggi-do (KR)

(21) Appl. No.: 19/285,366

(22) Filed: Jul. 30, 2025

(30) Foreign Application Priority Data
Jan. 9, 2025 (KR) 10-2025-0003154

(51) Int. Cl. H01M 50/553; H01M 10/04; H01M 50/595

(52) U.S. Cl. CPC H01M 50/553; H01M 10/0431; H01M 50/595; H01M 2200/00; H01M 2220/20

(57) ABSTRACT

A secondary battery including an electrode assembly including a first electrode plate including a first active material coated on a first substrate, a separator, and a second electrode plate including a second active material coated on a second substrate, wherein the first electrode plate, the separator, and the second electrode plate are wound to form a stacked configuration, a first strip terminal coupled to a winding leading edge uncoated portion of the first electrode plate, a second strip terminal coupled to a winding trailing edge uncoated portion of the second electrode plate, and a case configured to accommodate the electrode assembly, the first strip terminal, and the second strip terminal, wherein an end of the winding leading edge uncoated portion and an end of the winding trailing edge uncoated portion do not overlap each other.

### CROSS-REFERENCE TO RELATED APPLICATION

The present application claims priority to and the benefit of Korean Patent Application No. 10-2025-0003154, filed on Jan. 9, 2025, in the Korean Intellectual Property Office, the entire disclosure of which is incorporated herein by reference.

### BACKGROUND

### 1. Field

Embodiments of the present disclosure relate to a secondary battery.

### 2. Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

This Background section is for the general understanding of the background of the present disclosure, and therefore, it may contain information that does not constitute related (or prior) art.

### SUMMARY

Embodiments of the present disclosure provide a secondary battery that minimizes the risk of short circuit and ignition that may occur in the event of external impact or penetration.

Embodiments of the present disclosure provide a secondary battery including an electrode assembly configured such that a first electrode plate having a first active material coated on a first substrate, a separator, and a second electrode plate having a second active material coated on a second substrate are wound in a stacked state, a first strip terminal coupled to a winding leading edge uncoated portion of the first electrode plate, a second strip terminal coupled to a winding trailing edge uncoated portion of the second electrode plate, and a case configured to receive the electrode assembly and the first and second strip terminals.

Embodiments of the present disclosure provide a secondary battery including: an electrode assembly including a first electrode plate including a first active material coated on a first substrate, a separator, and a second electrode plate including a second active material coated on a second substrate, wherein the first electrode plate, the separator, and the second electrode plate are wound to form a stacked configuration; a first strip terminal coupled to a winding leading edge uncoated portion of the first electrode plate; a second strip terminal coupled to a winding trailing edge uncoated portion of the second electrode plate; and a case configured to accommodate the electrode assembly, the first strip terminal, and the second strip terminal, wherein an end of the winding leading edge uncoated portion and an end of the winding trailing edge uncoated portion do not overlap each other in a vertical direction.

In some embodiments, an end of the winding leading edge uncoated portion and an end of the winding trailing edge uncoated portion may not overlap each other.

In some embodiments, the end of the winding leading edge uncoated portion and the end of the winding trailing edge uncoated portion may not overlap each other in a vertical direction.

In some embodiments, the end of the winding leading edge uncoated portion and the end of the winding trailing edge uncoated portion may be spaced apart from each other in a horizontal direction.

In some embodiments, if a needle-shaped body penetrates the electrode assembly, the winding leading edge uncoated portion and the winding trailing edge uncoated portion may not be short-circuited by the needle-shaped body.

In some embodiments, an inner surface of the first strip terminal and the end of the winding leading edge uncoated portion may form the same plane.

In some embodiments, an inner surface of the first strip terminal and the end of the winding leading edge uncoated portion form a flush plane.

In some embodiments, the end of the winding leading edge uncoated portion may extend beyond the inner surface of the first strip terminal.

In some embodiments, an inner surface of the second strip terminal and the end of the winding trailing edge uncoated portion may form the same plane.

In some embodiments, an inner surface of the second strip terminal and the end of the winding trailing edge uncoated portion form a flush plane.

In some embodiments, the end of the winding trailing edge uncoated portion may extend beyond the inner surface of the second strip terminal.

In some embodiments, the first electrode plate may include a winding trailing edge uncoated portion provided at a winding trailing edge thereof.

In some embodiments, the electrode assembly may further include a third strip terminal coupled to the winding trailing edge uncoated portion of the first electrode plate.

In some embodiments, the first strip terminal and the third strip terminal may be located overlapping each other in the vertical direction.

In some embodiments, the first electrode plate further includes a winding trailing edge uncoated portion at a winding trailing edge, wherein the electrode assembly further includes a third strip terminal coupled to the winding trailing edge uncoated portion of the first electrode plate, and wherein the first strip terminal and the third strip terminal overlap each other in the vertical direction.

In some embodiments, the winding trailing edge uncoated portion of the first electrode plate may extend beyond the winding trailing edge uncoated portion of the second electrode plate.

In some embodiments, the second electrode plate may include a winding leading edge uncoated portion provided at a winding leading edge thereof.

In some embodiments, the electrode assembly may further include a fourth strip terminal coupled to the winding leading edge uncoated portion of the second electrode plate.

In some embodiments, the second strip terminal and the fourth strip terminal may be located overlapping each other in the vertical direction.

In some embodiments, the second electrode plate further includes a winding leading edge uncoated portion at a winding leading edge, wherein the electrode assembly further includes a fourth strip terminal coupled to the winding leading edge uncoated portion of the second electrode plate, and wherein the second strip terminal and the fourth strip terminal overlap each other in the vertical direction.

In some embodiments, the winding leading edge uncoated portion of the second electrode plate may extend beyond the winding leading edge uncoated portion of the first electrode plate.

Embodiments of the present disclosure provide a secondary battery including an electrode assembly configured such that a first electrode plate coated with a first active material, a separator, and a second electrode plate coated with a second active material are wound in a stacked state, a first strip terminal coupled to a winding leading edge uncoated portion of the first electrode plate, a second strip terminal coupled to a winding trailing edge uncoated portion of the second electrode plate, and a case configured to receive the electrode assembly and the first and second strip terminals, wherein an end of the winding leading edge uncoated portion is covered with a first insulating tape, and an end of the winding trailing edge uncoated portion is covered with a second insulating tape.

Embodiments of the present disclosure provide a secondary battery including: an electrode assembly including a first electrode plate including a first active material coated on a first substrate, a separator, and a second electrode plate including a second active material coated on a second substrate, wherein the first electrode plate, the separator, and the second electrode plate are wound to form a stacked configuration; a first strip terminal coupled to a winding leading edge uncoated portion of the first electrode plate; a second strip terminal coupled to a winding trailing edge uncoated portion of the second electrode plate; and a case configured to accommodate the electrode assembly, the first strip terminal, and the second strip terminal, wherein an end of the winding leading edge uncoated portion is at least partially covered with a first insulating tape, and wherein an end of the winding trailing edge uncoated portion is at least partially covered with a second insulating tape.

In some embodiments, the end of the winding leading edge uncoated portion and the end of the winding trailing edge uncoated portion may overlap each other.

In some embodiments, the end of the winding leading edge uncoated portion and the end of the winding trailing edge uncoated portion may overlap each other in the vertical direction.

In some embodiments, the first strip terminal may be covered with a first strip terminal cover tape different from the first insulating tape.

In some embodiments, the second strip terminal may be covered with a second strip terminal cover tape different from the second insulating tape.

In some embodiments, the first strip terminal is at least partially covered with a first strip terminal cover tape different from the first insulating tape, and wherein the second strip terminal is at least partially covered with a second strip terminal cover tape different from the second insulating tape.

In some embodiments, the first insulating tape may cover a front surface and a rear surface of the winding leading edge uncoated portion and the first strip terminal cover tape.

In some embodiments, the second insulating tape may cover a front surface and a rear surface of the winding trailing edge uncoated portion and the second strip terminal cover tape.

In some embodiments, the first insulating tape at least partially covers a front surface and a rear surface of the winding leading edge uncoated portion, and the first strip terminal cover tape, and wherein the second insulating tape at least partially covers a front surface and a rear surface of the winding trailing edge uncoated portion, and the second strip terminal cover tape.

In some embodiments, the end of the winding leading edge uncoated portion may extend beyond an inner surface of the first strip terminal, and the end of the winding trailing edge uncoated portion may extend beyond an inner surface of the second strip terminal.

In some embodiments, the first electrode plate may include a winding trailing edge uncoated portion provided at a winding trailing edge thereof.

In some embodiments, the electrode assembly may further include a third strip terminal coupled to the winding trailing edge uncoated portion of the first electrode plate.

In some embodiments, the first strip terminal and the third strip terminal may be located overlapping each other in the vertical direction.

In some embodiments, the first electrode plate includes a winding trailing edge uncoated portion at a winding trailing edge, wherein the electrode assembly further includes a third strip terminal coupled to the winding trailing edge uncoated portion of the first electrode plate, and wherein the first strip terminal and the third strip terminal overlap each other in a vertical direction.

In some embodiments, the second electrode plate may include a winding leading edge uncoated portion provided at a winding leading edge thereof.

In some embodiments, the electrode assembly may further include a fourth strip terminal coupled to the winding leading edge uncoated portion of the second electrode plate.

In some embodiments, the second strip terminal and the fourth strip terminal may be located overlapping each other in the vertical direction.

In some embodiments, the second electrode plate includes a winding leading edge uncoated portion at a winding leading edge, wherein the electrode assembly further includes a fourth strip terminal coupled to the winding leading edge uncoated portion of the second electrode plate, and wherein the second strip terminal and the fourth strip terminal overlap each other in a vertical direction.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 is a sectional view of a secondary battery according to an embodiment of the present disclosure;

FIG. 2 is a sectional view showing a first strip terminal according to an embodiment of the present disclosure;

FIG. 3 is a sectional view showing a second strip terminal according to an embodiment of the present disclosure;

FIG. 4 is a sectional view showing a needle-shaped body penetrating between the first strip terminal and the second strip terminal according to the embodiment of the present disclosure;

FIG. 5 is a sectional view of a secondary battery according to an embodiment of the present disclosure;

FIG. 6 is a sectional view showing installation of a first insulating tape according to an embodiment of the present disclosure;

FIG. 7 is a sectional view showing installation of a second insulating tape according to an embodiment of the present disclosure;

FIG. 8 is a sectional view showing a needle-shaped body penetrating between a first strip terminal and a second strip terminal according to an embodiment of the present disclosure;

FIG. 9 is a sectional view showing the first insulating tape installed while wrapping the first strip terminal according to an embodiment of the present disclosure;

FIG. 10 is a sectional view showing the second insulating tape installed while wrapping the second strip terminal according to an embodiment of the present disclosure;

FIGS. 11A and 11B are perspective views showing a battery pack including a secondary battery according to an embodiment of the present disclosure; and

FIGS. 12A and 12B are a perspective view and a side view, respectively, showing a vehicle including a battery pack according to an embodiment of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application.

In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

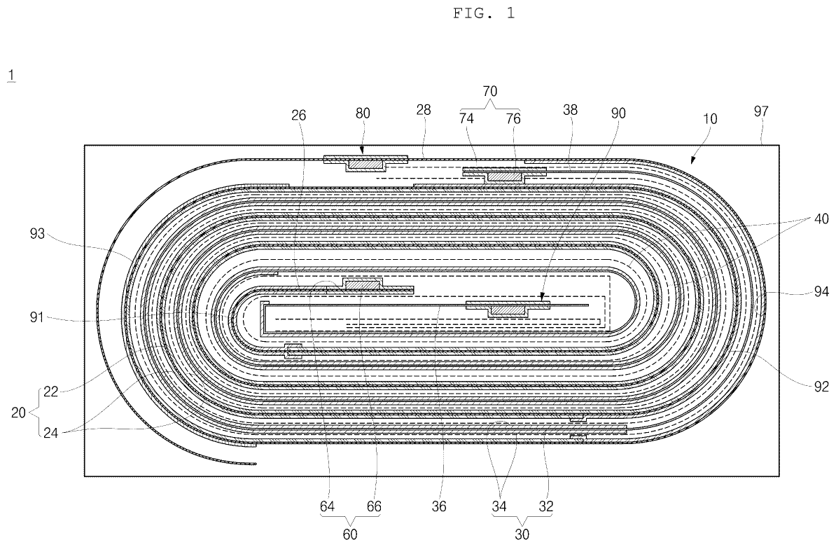

FIG. 1 is a sectional view of a secondary battery 1. As shown in FIG. 1, the secondary battery 1 may include an electrode assembly 10, a first strip terminal 60, a second strip terminal 70, and a case 97. The secondary battery 1 may include a third strip terminal 80 and/or a fourth strip terminal 90.

The electrode assembly 10 may include a first electrode plate 20 having a first active material 24 coated on a first substrate 22, a separator 40, and a second electrode plate 30 having a second active material 34 coated on a second substrate 32. The first electrode plate 20, the separator 40, and the second electrode plate 30 may be wound in a stacked configuration. The first electrode plate 20 and the second electrode plate 30 may be stacked in a configuration in which the separator 40 is interposed therebetween, and may be wound in a jelly-roll form. The electrode assembly 10 may include a first strip terminal 60 electrically coupled to the first electrode plate 20 and a second strip terminal 70 electrically coupled to the second electrode plate 30. The electrode assembly 10 may include a third strip terminal 80 electrically coupled to the first electrode plate 20 and/or a fourth strip terminal 90 electrically coupled to the second electrode plate 30.

The first electrode plate 20 may be a positive electrode plate, and the second electrode plate 30 may be a negative electrode plate. In other embodiments, the first electrode plate 20 may be a negative electrode plate, and the second electrode plate 30 may be a positive electrode plate. In the present disclosure, the first electrode plate 20 is described as a positive electrode plate and the second electrode plate 30 is described as a negative electrode plate.

The first electrode plate 20 may include a first substrate 22 including a thin aluminum foil and a first active material 24 coated on an outer surface of the first substrate 22, the first active material 24 having a lithium-based oxide as the main ingredient. The first electrode plate 20 may include a positive electrode uncoated portion, which is the area where the first substrate 22 is not coated with the first active material 24.

As used herein, the part of the electrode assembly 10 where front ends of the first electrode plate 20 and the second electrode plate 30 are located is defined as an inner circumference or a winding core of the electrode assembly 10, and the part of the electrode assembly 10 where rear ends of the first electrode plate 20 and the second electrode plate 30 are located is defined as an outer circumference or a winding end of the electrode assembly 10.

An uncoated portion of the first electrode plate 20 located at the winding core is referred to as a winding leading edge uncoated portion 26, and an uncoated portion of the second electrode plate 30 located at the winding core is referred to as a winding leading edge uncoated portion 36. An uncoated portion of the first electrode plate 20 located at the winding end is referred to as a winding trailing edge uncoated portion 28, and an uncoated portion of the second electrode plate 30 located at the winding end is referred to as a winding trailing edge uncoated portion 38. The winding leading edge uncoated portion 26 and the winding trailing edge uncoated portion 28 may be formed at opposite ends of the first electrode plate 20. The winding leading edge uncoated portion 36 and the winding trailing edge uncoated portion 38 may be formed at opposite ends of the second electrode plate 30. The first electrode plate 20 may include a winding trailing edge uncoated portion 28 provided at the winding trailing edge.

In some embodiments, the first electrode plate 20, the separator 40, and the second electrode plate 30, are wound in a jelly-roll form, and the uncoated portions may be formed at opposite ends of the first electrode plate 20 and the second electrode plate 30, wherein the uncoated portions where winding starts may be referred to as winding leading edge uncoated portions 26 and 36 and the uncoated portions where winding ends may be referred to as winding trailing edge uncoated portions 28 and 38.

A first tab 66 may be fixed to the uncoated portion provided at the first electrode plate 20 by ultrasonic welding. One side of the first tab 66 may be electrically coupled to the first electrode plate 20 of the electrode assembly 10, and the other side of the first tab 66 may extend to the outside of the electrode assembly 10. The first tab 66 may be coupled to a terminal located on the outside of the case 97, and various modifications are possible. The first tab 66 may include nickel or a nickel alloy, but other metal materials may be used.

The second electrode plate 30 may include a second substrate 32 and a second active material 34. The second electrode plate 30 may include a winding leading edge uncoated portion 36 and a winding trailing edge uncoated portion 38. The second electrode plate 30 may include a second substrate 32 made of a thin copper foil and a second active material 34 having a carbon material coated on an outer surface of the second substrate 32 as the main ingredient. In the second substrate 32, a negative electrode uncoated portion, which is the area where the second active material 34 is not coated, may be formed in a predetermined area at each of opposite ends of the negative electrode plate. A second tab 76 may be fixed to the winding trailing edge uncoated portion 38, which is the negative electrode uncoated portion, by ultrasonic welding. The second tab 76 may include nickel or a nickel alloy, and other metal materials may be used. The second electrode plate 30 may include a winding leading edge uncoated portion 36 provided at the winding leading edge thereof.

An end 27 of the winding leading edge uncoated portion 26 of the first electrode plate 20 and an end 39 of the winding trailing edge uncoated portion 38 of the second electrode plate 30 may not overlap each other. For example, the end 27 of the winding leading edge uncoated portion 26 of the first electrode plate 20 and the end 39 of the winding trailing edge uncoated portion 38 of the second electrode plate 30 may not overlap each other in a vertical direction. This arrangement may prevent electrical interference between the electrode plates, greatly improving the safety of the battery. In instances where a needle-shaped body 98 moves between the first strip terminal 60 and the second strip terminal 70, any short circuiting that may have been caused by the needle-shaped body 98 may be prevented because the winding leading edge uncoated portion 26 of the first electrode plate 20 and the winding trailing edge uncoated portion 38 of the second electrode plate 30 do not overlap each other in the vertical direction. In instances where the needle-shaped body 98 penetrates the electrode assembly 10, the needle-shaped body 98 may deviate from an electrical conduction path between the electrode plates, thereby blocking current transmission.

The end 27 of the winding leading edge uncoated portion 26 of the first electrode plate 20 and the end 39 of the winding trailing edge uncoated portion 38 of the second electrode plate 30 may be spaced apart from each other in a horizontal direction. The winding leading edge uncoated portion 26 of the first electrode plate 20 may be located at the winding core of the electrode assembly 10, and the winding trailing edge uncoated portion 38 of the second electrode plate 30 may be located at the winding end of the electrode assembly 10. Therefore, the end 27 of the winding leading edge uncoated portion 26 of the first electrode plate 20 and the end 39 of the winding trailing edge uncoated portion 38 of the second electrode plate 30 may be spaced apart from each other in the horizontal direction to reduce the possibility of short circuit.

The winding trailing edge uncoated portion 28 of the first electrode plate 20 may extend beyond the winding trailing edge uncoated portion 38 of the second electrode plate 30. The second electrode plate 30 may be located on the outside of the first electrode plate 20, and the winding trailing edge uncoated portion 28 of the first electrode plate 20 may extend beyond the winding trailing edge uncoated portion 38 of the second electrode plate 30.

The winding leading edge uncoated portion 36 of the second electrode plate 30 may extend beyond the winding leading edge uncoated portion 26 of the first electrode plate 20. The second electrode plate 30 may be located on the inside of the first electrode plate 20, and the winding leading edge uncoated portion 36 of the second electrode plate 30 may extend beyond the winding leading edge uncoated portion 26 of the first electrode plate 20.

The separator 40 may be disposed between the first electrode plate 20 and the second electrode plate 30 to provide insulation between the first electrode plate 20 and the second electrode plate 30. The separator 40 may be made of polyethylene, polypropylene, or a composite film of polyethylene and polypropylene. The separator 40 may have a width greater than that of the first electrode plate 20 and that of the second electrode plate 30, and may protrude upwardly and downwardly of the first electrode plate 20 and the second electrode plate 30.

The first strip terminal 60 may be coupled to the winding leading edge uncoated portion 26 of the first electrode plate 20. The first strip terminal 60 may be located at the winding center of the electrode assembly 10 and may be electrically coupled to the first electrode plate 20. The third strip terminal 80 may be located above the first strip terminal 60. The first strip terminal 60 may be installed at the winding leading edge uncoated portion 26 of the first electrode plate 20, and the third strip terminal 80 may be located at the winding trailing edge uncoated portion 28 of the first electrode plate 20. The electrode assembly 10 may include a third strip terminal 80 coupled to the winding trailing edge uncoated portion 28 of the first electrode plate 20. The first strip terminal 60 and the third strip terminal 80 may be located overlapping each other in the vertical direction. The first strip terminal 60 and the third strip terminal 80 may be electrically coupled to each other on the outside of the electrode assembly 10.

The second strip terminal 70 may be coupled to the winding trailing edge uncoated portion 38 of the second electrode plate 30. The second strip terminal 70 may be located at the winding end of the electrode assembly 10 and may be electrically coupled to the second electrode plate 30. The fourth strip terminal 90 may be located under the second strip terminal 70. The fourth strip terminal 90 may be installed at the winding leading edge uncoated portion 36 of the second electrode plate 30, and the second strip terminal 70 may be located at the winding trailing edge uncoated portion 38 of the second electrode plate 30. The electrode assembly 10 may further include a fourth strip terminal 90 coupled to the winding leading edge uncoated portion 36 of the second electrode plate 30. The second strip terminal 70 and the fourth strip terminal 90 may be located overlapping each other in the vertical direction. The second strip terminal 70 and the fourth strip terminal 90 may be electrically coupled to each other on the outside of the electrode assembly 10.

The case 97 may have various geometries as long as the case 97 can receive the electrode assembly 10 and the first and second strip terminals 60 and 70. The case 97 may be a soft pouch or may have a can geometry.

The uncoated portions of the electrode assembly 10 may be wrapped with a protective tape. The protective tape may include an insulating material including a resin including a fluoro-resin, such as polytetrafluoroethylene (PTFE), tetrafluoroethylene hexafluoropropylene copolymer (FEP), tetrafluoroethylene-ethylene copolymer (ETFE), a tetrafluoroethylene-perfluoroalkyl vinyl ether copolymer (PFA), or polyvinylidene fluoride (PVDF), polyimide, liquid crystal polymer (LCP), polyphenylene sulfide (PPS), polybutylene terephthalate (PBT), polyethylene terephthalate (PET), polyethylene (PE), polypropylene (PP), polyvinyl chloride (PVC), or an acetate resin. The insulating tape may include any insulating material that exhibits high stability against an electrolyte or lithium ions. The protective tape may include a first protective tape 91, a second protective tape 92, a third protective tape 93, and a fourth protective tape 94.

The first protective tape 91 may be attached to the exterior of the winding leading edge uncoated portion 26 of the first electrode plate 20. The first protective tape 91 may not be attached to the part where the first strip terminal 60 is installed.

The first active material 24 may be applied only to an inner circumferential part of the first electrode plate 20, and the area where first active material 24 is not applied may be provided at an outer circumferential part of the first electrode plate 20. In some embodiments, the area of the first electrode plate 20 where the first active material 24 is applied only to the inner circumferential part thereof is curved, and the second protective tape 92 may be installed on an outer curved surface of the first electrode plate 20.

The third protective tape 93 may be located on an outer circumferential part of the electrode assembly 10. In some embodiments, the area of the first electrode plate 20 where the first active material 24 is applied only to the inner circumferential part thereof is curved, and the third protective tape 93 may be installed on the outer curved surface of the first electrode plate 20.

The fourth protective tape 94 may be attached to an inner surface of the winding trailing edge uncoated portion 28 of the first electrode plate 20. The fourth protective tape 94 may be installed on the interior of a curved surface where the winding trailing edge uncoated portion 28 of the first electrode plate 20 is curved.

The first protective tape 91, the second protective tape 92, the third protective tape 93, and the fourth protective tape 94 may be sequentially installed in a direction from the winding core to the winding end of the first electrode plate 20.

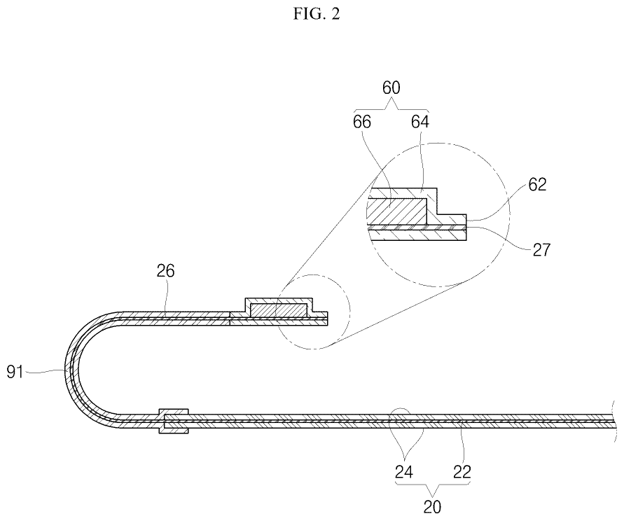

FIG. 2 is a sectional view showing a first strip terminal 60.

The first strip terminal 60 may be installed on the winding leading edge uncoated portion 26 provided on the first electrode plate 20. The first strip terminal 60 may include a first tab 66 and a first strip terminal cover tape 64. The first tab 66 may be fixed to the winding leading edge uncoated portion 26 and be in contact with the winding leading edge uncoated portion 26 by welding. The first tab 66 and the winding leading edge uncoated portion 26 may be electrically coupled to each other. In some embodiments, the first tab 66 is fixed to the winding leading edge uncoated portion 26 of the first electrode plate 20, and the first strip terminal cover tape 64 may be installed so as to wrap the first tab 66. The first strip terminal cover tape 64 may include an insulating material, and may include substantially the same material as or a similar material to the first protective tape 91.

The winding leading edge uncoated portion 26 to which the first strip terminal 60 is fixed may not extend to the exterior of the first strip terminal 60. An inner surface 62 of the first strip terminal 60 and the end 27 of the winding leading edge uncoated portion 26 may form a flush plane. An end of the first strip terminal cover tape 64 and the end 27 of the winding leading edge uncoated portion 26 of the first electrode plate 20 may form a flush plane in the vertical direction.

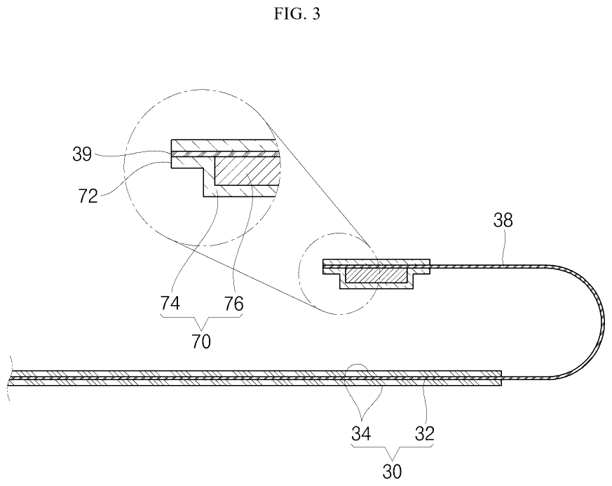

FIG. 3 is a sectional view showing a second strip terminal 70.

The second strip terminal 70 may be installed on the winding trailing edge uncoated portion 38 provided on the second electrode plate 30. The second strip terminal 70 may include a second tab 76 and a second strip terminal cover tape 74. The second tab 76 may be fixed to the winding trailing edge uncoated portion 38 of the second electrode plate 30 and be in contact with the winding trailing edge uncoated portion 38 by welding. The second tab 76 and the winding trailing edge uncoated portion 38 of the second electrode plate 30 may be electrically coupled to each other. In some embodiments, the second tab 76 is fixed to the winding trailing edge uncoated portion 38 of the second electrode plate 30, and the second strip terminal cover tape 74 may be installed so as to wrap the second tab 76. The second strip terminal cover tape 74 may include an insulating material, and may include substantially the same material as or a similar material to the first protective tape 91.

The winding trailing edge uncoated portion 38 to which the second strip terminal 70 is fixed may not extend to the exterior of the second strip terminal 70. An inner surface 72 of the second strip terminal 70 and the end 39 of the winding trailing edge uncoated portion 38 may form a flush plane. An end of the second strip terminal cover tape 74 and the end 39 of the winding trailing edge uncoated portion 38 of the second electrode plate 30 may form a flush plane in the vertical direction.

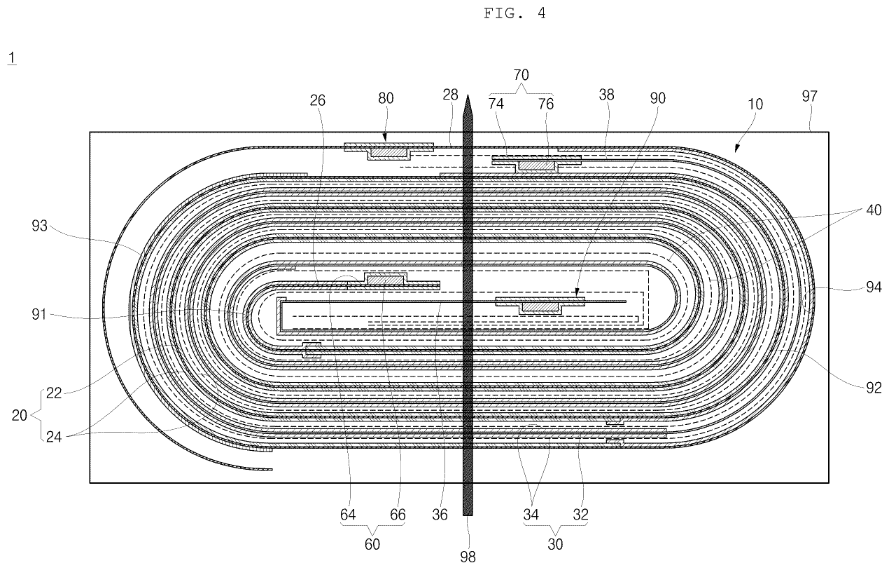

FIG. 4 is a sectional view showing a needle-shaped body 98 penetrating between the first strip terminal 60 and the second strip terminal 70. As shown in FIG. 4, the needle-shaped body 98 may penetrate the electrode assembly 10; however, the winding leading edge uncoated portion 26 of the first electrode plate 20 and the winding trailing edge uncoated portion 38 of the second electrode plate 30 may not be short-circuited by the needle-shaped body 98.

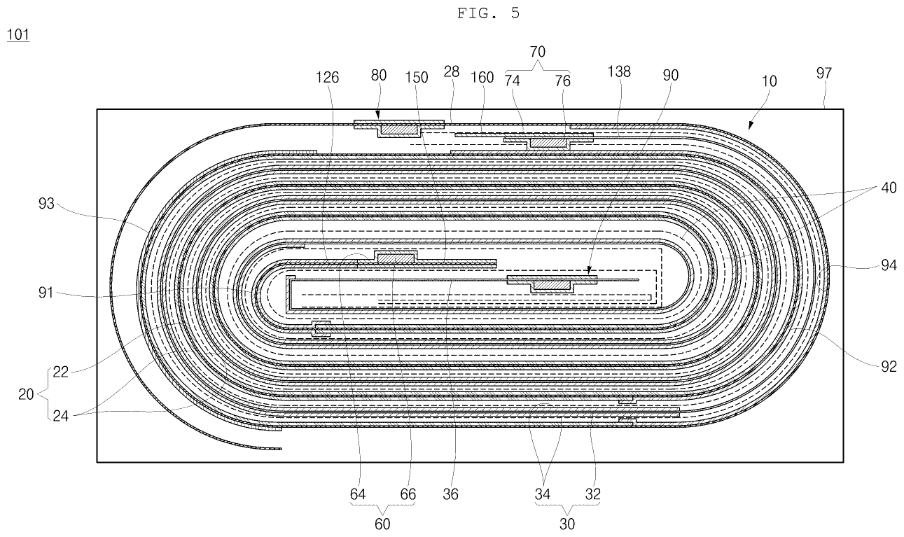

FIG. 5 is a sectional view of a secondary battery 101. As shown in FIG. 5, the secondary battery 101 may include an electrode assembly 10 having a first electrode plate 20 (coated with a first active material 24), a separator 40, and a second electrode plate 30 (coated with a second active material 34) wound in a stacked configuration. A first strip terminal 60 is coupled to a winding leading edge uncoated portion 126 of the first electrode plate 20, a second strip terminal 70 is coupled to a winding trailing edge uncoated portion 138 of the second electrode plate 30, and a case 97 is configured to receive the electrode assembly 10 and the first and second strip terminals 60 and 70.

The second electrode plate 30 may include a winding leading edge uncoated portion 36 provided at a winding leading edge. An end 127 of the winding leading edge uncoated portion 126 of the first electrode plate 20 and an end 139 of the winding trailing edge uncoated portion 138 of the second electrode plate 30 may overlap each other. The end 127 of the winding leading edge uncoated portion 126 of the first electrode plate 20 and the end 139 of the winding trailing edge uncoated portion 138 of the second electrode plate 30 may overlap each other in the vertical direction.

The electrode assembly 10 may include a third strip terminal 80 coupled to the winding trailing edge uncoated portion 28 of the first electrode plate 20. The first and third strip terminals 60 and 80 may be located overlapping each other in the vertical direction.

The second electrode plate 30 may include a winding leading edge uncoated portion 36 provided at winding leading edge. The electrode assembly 10 may include a fourth strip terminal 90 coupled to the winding leading edge uncoated portion 36 of the second electrode plate 30. The second and fourth strip terminals 70 and 90 may be located overlapping each other in the vertical direction.

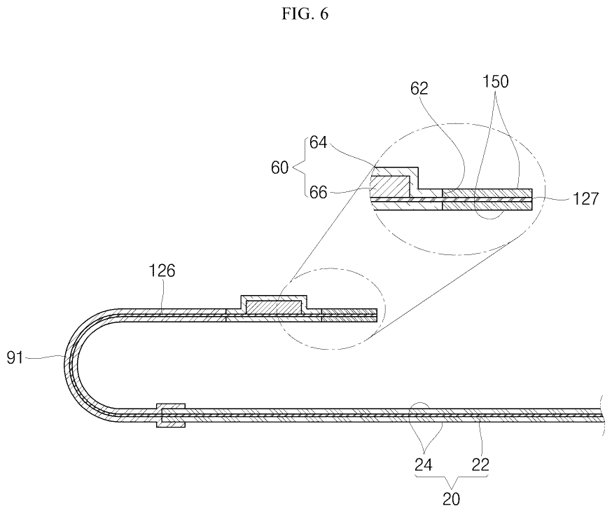

FIG. 6 is a sectional view showing a first insulating tape 152. As shown in FIGS. 5 and 6, the winding leading edge uncoated portion 126 of the first electrode plate 20 may be covered with the first insulating tape 152.

The winding leading edge uncoated portion 126 of the first electrode plate 20 may extend to the exterior of the first strip terminal 60. For example, the end 127 of the winding leading edge uncoated portion 126 may extend beyond an inner surface 62 of the first strip terminal 60. The inner surface 62 of the first strip terminal 60 may be the same surface as an end of a first strip terminal cover tape 64.

The first strip terminal 60 may be covered with the first strip terminal cover tape 64, which is different from the first insulating tape 152. The first insulating tape 150 may be attached to the outside of the winding leading edge uncoated portion 126 extending to the exterior of the first strip terminal 60. The first insulating tape 150 and the first strip terminal cover tape 64 may include substantially the same material, but various modifications are possible. For example, the first insulating tape 150 and the first strip terminal cover tape 64 may include different materials as needed.

The end 127 of the winding leading edge uncoated portion 126 of the first electrode plate 20 may be spaced apart from the inner surface 62 of the first strip terminal 60, and may be located on the outside of the first strip terminal 60. The winding leading edge uncoated portion 126 of the first electrode plate 20 may extend in a horizontal direction of the first strip terminal 60.

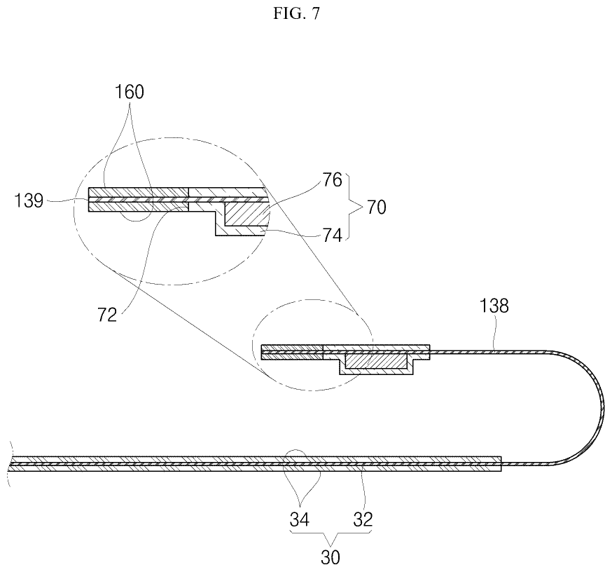

FIG. 7 is a sectional view showing a second insulating tape 160. As shown in FIG. 7, the second electrode plate 30 may include a winding trailing edge uncoated portion 138 provided at a winding trailing edge thereof.

The winding trailing edge uncoated portion 138 of the second electrode plate 30 may be covered with the second insulating tape 160.

The winding trailing edge uncoated portion 138 of the second electrode plate 30 may extend to the exterior of the second strip terminal 70. For example, the end 139 of the winding trailing edge uncoated portion 138 may extend beyond an inner surface 72 of the second strip terminal 70. The inner surface 72 of the second strip terminal 70 may be the same surface as an end of a second strip terminal cover tape 74.

The second strip terminal 70 may be covered with the second strip terminal cover tape 74, which is different from the second insulating tape 160. The second insulating tape 160 may be attached to the exterior of the winding trailing edge uncoated portion 138 extending to the exterior of the second strip terminal 70. The second insulation tape 160 and the second strip terminal cover tape 74 may include substantially the same material, but various modifications are possible. For example, the second insulation tape 160 and the second strip terminal cover tape 74 may include different materials as needed.

The end 139 of the winding trailing edge uncoated portion 138 of the second electrode plate 30 may be spaced apart from the inner surface 72 of the second strip terminal 70, and may be located on the outside of the second strip terminal 70. The winding trailing edge uncoated portion 138 of the second electrode plate 30 may extend in a horizontal direction of the second strip terminal 70.

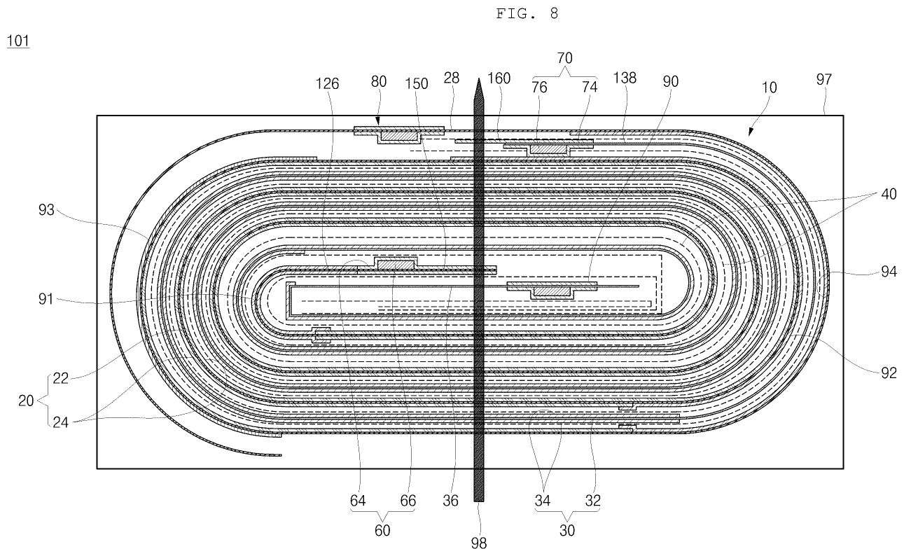

FIG. 8 is a sectional view showing a needle-shaped body 98 penetrating between the first strip terminal 60 and the second strip terminal 70.

As shown in FIG. 8, the winding trailing edge uncoated portion 138 of the second electrode plate 30 may be located above the winding leading edge uncoated portion 126 of the first electrode plate 20. The winding leading edge uncoated portion 126 of the first electrode plate 20 and the winding trailing edge uncoated portion 138 of the second electrode plate 30 may overlap each other in the vertical direction. In some embodiments, the needle-shaped body 98 may penetrate the electrode assembly 10 in the vertical direction, electrically connecting the winding leading edge uncoated portion 126 of the first electrode plate 20 and the winding trailing edge uncoated portion 138 of the second electrode plate 30. In order to prevent such an electrical connection between the winding leading edge uncoated portion 126 of the first electrode plate 20 and the winding trailing edge uncoated portion 138 of the second electrode plate 30, the first insulating tape 150 and the second insulating tape 160 may be installed. Advantageously, even if the needle-shaped body 98 penetrates the winding leading edge uncoated portion 126 of the first electrode plate 20 on which the first insulating tape 150 is installed and the winding trailing edge uncoated portion 138 of the second electrode plate 30 on which the second insulating tape 160 is installed, no short circuiting may occur.

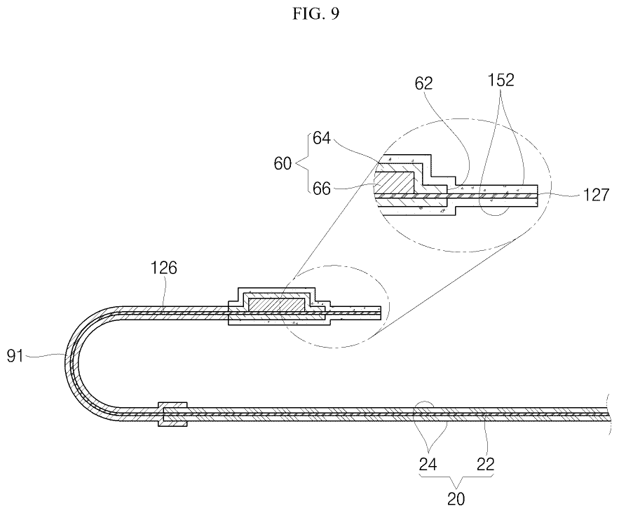

FIG. 9 is a sectional view showing the first insulating tape 152 installed while wrapping the first strip terminal 60. As shown in FIG. 9, the first insulating tape 152 may cover a front surface and a rear surface of the winding leading edge uncoated portion 126 and the first strip terminal cover tape 64. The first insulating tape 152 may be installed on the exterior of the first strip terminal 60 and on the exterior of the winding leading edge uncoated portion 126 protruding to the exterior of the first strip terminal 60. The first strip terminal cover tape 64 may be omitted, and the first insulating tape 152 may be installed while wrapping the front surface and the rear surface of the winding leading edge uncoated portion 126 and the outer side of the first tab 66, and various other modifications are possible.

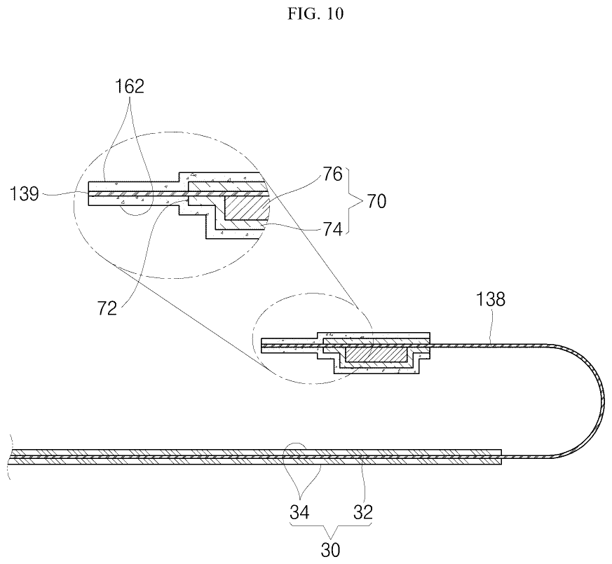

FIG. 10 is a sectional view showing the second insulating tape 162 installed while wrapping the second strip terminal 70. As shown in FIG. 10, the second insulating tape 162 may cover a front surface and a rear surface of the winding trailing edge uncoated portion 138 and the second strip terminal cover tape 74. The second insulating tape 162 may be installed on the exterior of the second strip terminal 70 and on the exterior of the winding trailing edge uncoated portion 138 protruding to the exterior of the second strip terminal 70. The second strip terminal cover tape 74 may be omitted, and the second insulating tape 162 may be installed while wrapping the front surface and the rear surface of the winding trailing edge uncoated portion 138 and the outside of the second tab 76, and various other modifications are possible.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

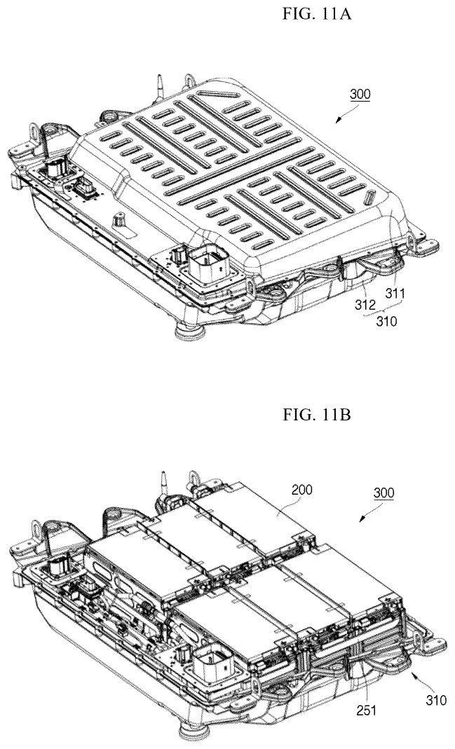

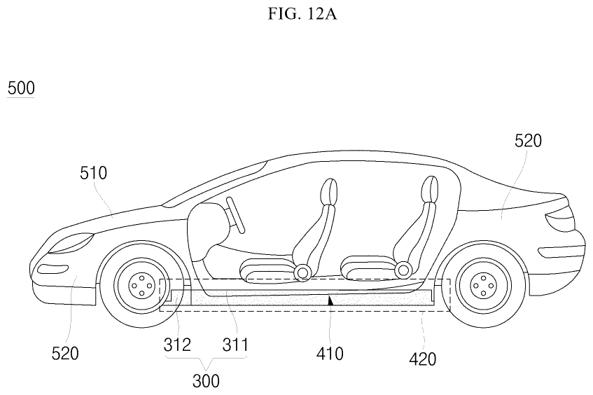

The batteries according to the above-described embodiments may be used to manufacture a battery pack. FIGS. 11A and 11B are perspective views showing a battery pack including the secondary battery. Referring to FIGS. 11A and 11B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

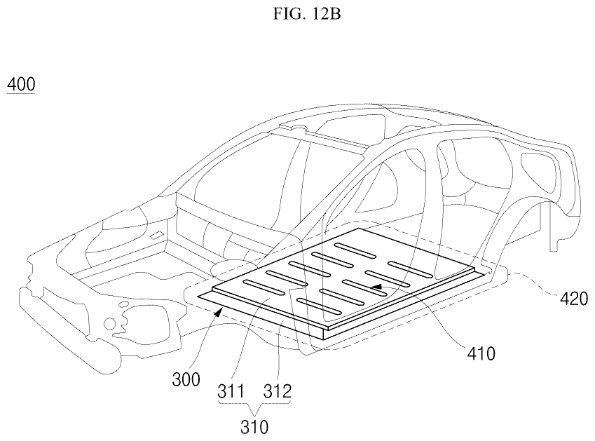

FIGS. 12A and 12B are, respectively, a perspective view and a side view showing vehicles 400 and 500 including the battery pack 300.

In FIG. 12A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 12B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to embodiments of the present disclosure, the area of each of a positive electrode and a negative electrode where a substrate is exposed may be removed to prevent the occurrence of electrical contact between the substrates due to a needle-shaped body, whereby it is possible to improve safety of a secondary battery.

According to embodiments of the present disclosure, an insulating tape may be attached to the area where the substrate is exposed, whereby it is possible to minimize the risk of short circuit and ignition in the event of external impact or penetration.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
an electrode assembly comprising a first electrode plate comprising a first active material coated on a first substrate, a separator, and a second electrode plate comprising a second active material coated on a second substrate, wherein the first electrode plate, the separator, and the second electrode plate are wound to form a stacked configuration;
a first strip terminal coupled to a winding leading edge uncoated portion of the first electrode plate;
a second strip terminal coupled to a winding trailing edge uncoated portion of the second electrode plate; and
a case configured to accommodate the electrode assembly, the first strip terminal, and the second strip terminal,
wherein an end of the winding leading edge uncoated portion and an end of the winding trailing edge uncoated portion do not overlap each other in a vertical direction.

2. The secondary battery as claimed in claim 1, wherein the end of the winding leading edge uncoated portion and the end of the winding trailing edge uncoated portion are spaced apart from each other in a horizontal direction.

3. The secondary battery as claimed in claim 1, wherein an inner surface of the first strip terminal and the end of the winding leading edge uncoated portion form a flush plane.

4. The secondary battery as claimed in claim 1, wherein the end of the winding leading edge uncoated portion extends beyond an inner surface of the first strip terminal.

5. The secondary battery as claimed in claim 1, wherein an inner surface of the second strip terminal and the end of the winding trailing edge uncoated portion form a flush plane.

6. The secondary battery as claimed in claim 1, wherein the end of the winding trailing edge uncoated portion extends beyond an inner surface of the second strip terminal.

7. The secondary battery as claimed in claim 1, wherein the first electrode plate further comprises a winding trailing edge uncoated portion at a winding trailing edge,
wherein the electrode assembly further comprises a third strip terminal coupled to the winding trailing edge uncoated portion of the first electrode plate, and wherein the first strip terminal and the third strip terminal overlap each other in the vertical direction.

8. The secondary battery as claimed in claim 7, wherein the winding trailing edge uncoated portion of the first electrode plate extends beyond the winding trailing edge uncoated portion of the second electrode plate.

9. The secondary battery as claimed in claim 1, wherein the second electrode plate further comprises a winding leading edge uncoated portion at a winding leading edge,
wherein the electrode assembly further comprises a fourth strip terminal coupled to the winding leading edge uncoated portion of the second electrode plate, and wherein the second strip terminal and the fourth strip terminal overlap each other in the vertical direction.

10. The secondary battery as claimed in claim 9, wherein the winding leading edge uncoated portion of the second electrode plate extends beyond the winding leading edge uncoated portion of the first electrode plate.

11. A secondary battery comprising:
an electrode assembly comprising a first electrode plate comprising a first active material coated on a first substrate, a separator, and a second electrode plate comprising a second active material coated on a second substrate, wherein the first electrode plate, the separator, and the second electrode plate are wound to form a stacked configuration;
a first strip terminal coupled to a winding leading edge uncoated portion of the first electrode plate;
a second strip terminal coupled to a winding trailing edge uncoated portion of the second electrode plate; and
a case configured to accommodate the electrode assembly, the first strip terminal, and the second strip terminal,
wherein an end of the winding leading edge uncoated portion is at least partially covered with a first insulating tape, and
wherein an end of the winding trailing edge uncoated portion is at least partially covered with a second insulating tape.

12. The secondary battery as claimed in claim 11, wherein the end of the winding leading edge uncoated portion and the end of the winding trailing edge uncoated portion overlap each other in a vertical direction.

13. The secondary battery as claimed in claim 11, wherein the first strip terminal is at least partially covered with a first strip terminal cover tape different from the first insulating tape, and wherein the second strip terminal is at least partially covered with a second strip terminal cover tape different from the second insulating tape.

14. The secondary battery as claimed in claim 13, wherein the first insulating tape at least partially covers a front surface and a rear surface of the winding leading edge uncoated portion, and the first strip terminal cover tape, and wherein the second insulating tape at least partially covers a front surface and a rear surface of the winding trailing edge uncoated portion, and the second strip terminal cover tape.

15. The secondary battery as claimed in claim 11, wherein the end of the winding leading edge uncoated portion extends beyond an inner surface of the first strip terminal, and wherein the end of the winding trailing edge uncoated portion extends beyond an inner surface of the second strip terminal.

16. The secondary battery as claimed in claim 11, wherein the first electrode plate comprises a winding trailing edge uncoated portion at a winding trailing edge, wherein the electrode assembly further comprises a third strip terminal coupled to the winding trailing edge uncoated portion of the first electrode plate, and wherein the first strip terminal and the third strip terminal overlap each other in a vertical direction.

17. The secondary battery as claimed in claim 11, wherein the second electrode plate comprises a winding leading edge uncoated portion at a winding leading edge, wherein the electrode assembly further comprises a fourth strip terminal coupled to the winding leading edge uncoated portion of the second electrode plate, and wherein the second strip terminal and the fourth strip terminal overlap each other in a vertical direction.
